(19) United States
(12) Patent Application Publication
(10) Pub. No.: US 2020/0299149 A1
(43) Pub. Date: Sep. 24, 2020

(54) Method to remove solids in contaminated water

(71) Applicant: John Francis Pires, Kansas City, MO (US)

(72) Inventor: John Francis Pires, Kansas City, MO (US)

(21) Appl. No.: 16/501,271

(22) Filed: Mar. 18, 2019

(51) Int. Cl. C02F 1/04; C02F 1/14; B01D 1/00; B01D 1/30

(52) U.S. Cl. CPC C02F 1/043; C02F 1/14; C02F 2103/007; B01D 1/30; B01D 1/0035

(57) ABSTRACT

The world suffers from a refugee crisis. There are millions of people homeless and displaced by war, poverty, terrorism and the world economy. Hunger and thirst are rampant. Millions of people live in refugee camps. I knew that I could not help the hunger problem except by donations to charities. So, I thought about the lack of water problem. Millions of people live by the sea and ocean. People have access to salt water. People have been removing salt from the sea and ocean from hundreds of years, if not more, by evaporation. The solution to provide people with salt free water was to collect salt water, sea water or ocean water in a container. Evaporate the salt water and in the evaporation process, transfer the purer water, (salt(NaCl) free) to another container. I developed a method to accomplish this task. A process to transfer salt(NaCl) water or contaminated water to another container, purer than before. During this process of providing salt(NaCl) free water to people, I realized that this method not only works for salt removal but also works for feces removal and other contaminated water, such as dirty water from rivers, canals, swamps, streams, lakes, etc.

My patent is a way to transfer contaminated water salt(NaCl) water) to purer water by using two containers, an energy source, evaporation, a vapor/water passage, a truncated cone and a pressure plate.

### PART A

Obtain two containers. Container A is filled with salt(NaCl) water, i.e., sea water or ocean water. Container B is empty. Each container has a lid. Inside, Container A, is a truncated cone. The sides of the truncated cone and its bottom are drilled with holes. I drill holes sides of the truncated cone to permit water in Container A to enter the truncated cone. I drill holes in the base of the truncated cone to enhance the sealing process or bonding between the truncated cone and Container A. I scuffed the base of the truncated cone. By scuffing the base, this permits more surface area to be bonded between the truncated cone and Container A. The base of the truncated cone is oval shaped, with a truncated cone. A pyramid will work also. A vapor/water passage exits the Container A. It can exit at the lid top or near the top lid along its sides. The vapor/water passage may be a tube, a cylinder or a straw, etc. let call the vapor water passage a straw and have it exit at the top of Container A Container B is below Container A. The water, that exits Container A, must eventually, go downward to Container B. The water exiting Container A will use the force of gravity to flow to Container B. A pressure plate is inside Container A. The pressure plate surrounds the truncated cones. The purpose of the pressure plate is to pressure the water inside the Container A and inside the truncated cone. As water exits Container A, the pressure plate will drop down and eventually stop dropping as it reaches the walls of the truncated cone. This can be accomplished by trial and error. How much the pressure drops, the cut out of the opening in the pressure plate, the pressure exerted by the pressure plate, the rate of water transfer to Container B can be accomplished trial and error or by calculations. This will speed up the transfer rate from the contaminated water in Container A to purer water to Container B. I drill a hole in Container B. The purpose of this hole in Container B is to allow the vapor/water passage enter Container B. The hole diameter must be enough to allow the water passage to enter Container B.

Container A is heated. Vapor rises and vapor/water enters the vapor/water passage. The water vapor condenses into water and transfers to Containers. The salt(NaCl) remains in Container A.

It works just like it is. To make the water transfer from salt water to purer water better, correct the main problem, which is vapor leak. All openings should be sealed to prevent water vapor leaving Container A, other than the water vapor that enters the vapor/water passage to Container B. The bottom of the truncated cone has a lip or edge. I used red RTV to seal the bottom of the truncated cone. This stability displays as water vapor rises in the direction of the opening at the top of the top of the truncated cone.

Many methods can be used to heat Container A. Paint Container A black and place it in the sun. Or bury it in sand. But remember. Container B must be below Container A. Use sand, rocks, metal, such as iron, to heat Container A. Use magnifying glasses or lenses. Use wood, coal, oil, fossil fuels, electricity, gas, steam, etc. Place Container B in the shade.

### PART B

My patent is very crude and not professional. I am pretty sure that the red RTV is toxic. When I was applying to seal the base of the truncated cone, I realize that I would not eat it. The truncated cone is made out of some type of rubber. For a pressure plate, I used a lid cut out of a Mason jar. The red straw I used came from the same Mason that I used to as a pressure plate. All materials I used came from local retailers. The truncated cone and the pressure plate have to fit inside Container A. The lid on the teapot has to big enough to allow the truncated cone and the pressure plate to allow entry to the tea pot, i.e., Container A.

I am a micro entity. All I wanted to do was to show the principal or method to transfer contaminated water, the salt(NaCl) water to purer water. I believe it will save lives. Instead of plastic straws, something sturdier should be use. In July 2018, I used the sun to heat Container A. Earlier, around July, 2018, I tried a Mason jar and an aluminum can. I placed the two containers side by side. The vapor/water passage water was a rubber straw between the two containers. The rubber straw made an inverted U. Inside the rubber straw, were two plastic straws going to Container A and Container B. Also, there were clear tubing in line with the rubber tubing. In the transfer process, I noticed that one or two inches of water in the clear tubing. I realized that the water must go downward to Container B. Because the force gravity so great that the water will rise but never transfer to Container B without a downward slope.

### PART C

This patent was originally thought up with the individual in mind. Perhaps, commercial companies will exist based on this principal of transferring contaminated water, salt(NaCl) to purer water. I used a truncated cone. I mentioned using a pyramid. Many shapes and configurations can be used.

### PART D

If commercial or profited companies use this method described above, they must follow the laws and regulations of the US and the states, counties, municipalities, cities, etc.

### PART E

This process will work for salt water or sea water or ocean water, in contaminated water in creeks, rivers, lakes, lagoons, swamp water, dirty water, muddy water or other types of water.

1. A method to remove solids in contaminated water to purer water by using two containers, an energy source, evaporation, a vapor/water passage, the force of gravity, a truncated cone and a pressure plate. This method is works by transferring the purer water to another container and leaving the solid in the contaminated container. Originally, This was thought to remove salt(NaCl) from saltwater or ocean water. This method, not only works for salt(NaCl) removal, but other solids, such as feces removal, dirt removal, sand removal, etc.
